(19) United States
(12) Patent Application Publication
(10) Pub. No.: US 2010/0114876 A1
(43) Pub. Date: May 6, 2010

(54) System and Method for Search Result Sharing

(76) Inventors: Edward W. Mandel, Frisco, TX (US); Enrique Sanchez, JR., Frisco, TX (US)

Correspondence Address: CARSTENS & CAHOON, LLP, P O BOX 802334, DALLAS, TX, 75380, US

(21) Appl. No.: 12/330,004

(22) Filed: Dec. 8, 2008

Related U.S. Application Data
(63) Continuation-in-part of application No. 12/323,899, filed on Nov. 26, 2008.
Application No. 12/323,899 is a continuation-in-part of application No. 12/265,804, filed on Nov. 6, 2008.

(51) Int. Cl. G06F 17/30; G06F 3/048; G06F 7/00

(52) U.S. Cl. 707/722; 715/733; 707/E17.014; 707/E17.032

(57) ABSTRACT

A system and method for facilitating the sharing of the results of a search for information conducted by a user over a computer network. The results are presented to the user along with links to allow one or more of the search results to be shared over the network. The user elects to share a particular search result and chooses a sharing destination, such as an email address or a social networking website. The system formats the sharing message appropriately according to the chosen destination and according to a predetermined view template. The message is then submitted to the destination.

### CROSS-REFERENCE TO RELATED APPLICATIONS

This application is a continuation-in-part of U.S. patent application Ser. No. 12/323,899, which was filed on Nov. 26, 2008 and which is a continuation-in-part of U.S. patent application Ser. No. 12/265,804, which was filed on Nov. 6, 2008.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to web search services, and more specifically to search result sharing systems.

2. Description of Related Art Including Information Disclosed Under 37 CFR 1.97 and 1.98

Search engine users spend a lot of time looking for what they want. Once they find it, they would find it convenient to share their results with others. Traditional sharing of search results entails sending an e-mail with a link to the web page, but this falls far short of Web 2.0 standards. Further, many search engine visitors have social sharing accounts where they network with others by posting messages to accounts. Again, the lack of content is astounding. Text, images, and other media can be posted to a social sharing sight, but lack the cohesion required for search result sharing.

### BRIEF SUMMARY OF THE INVENTION

The present invention provides a method, system, and computer software for sharing search results in a networked environment. The system first provides a plurality of search results in response to a search for information by a user on a computer network. In addition, the system provides a hyperlink to initiate a request to share at least one of the results. If the user chooses to share a result, he or she also must provide the system with a destination for the shared result message. Once the destination is chosen, the sharing message is generated based, at least in part, on the destination. Finally, the sharing message is communicated to the destination. The destination for the sharing message can be an email address, a social networking website, or even a link in the user's browser “favorites” folder.

In other embodiments, the system allows the user to select less than the totality of the search results for sharing. In addition, the system may provide predefined view templates that can be applied to the resulting sharing message. Thus, the message can be properly formatted per the view template to present the search results content in a predefined fashion, such as a summary view, a gallery view, or a line view.

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 exemplifies a diagram of a search result sharing system in a networked environment, in accordance with principles of the present invention; and

FIG. 2 exemplifies a diagram of a method for sharing search results, in accordance with principles of the present invention.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,”, “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, digital content, and the like have been omitted inasmuch as such details are not considered necessary to obtain a complete understanding of the present invention, and are considered to be within the skills of persons of ordinary skill in the relevant art.

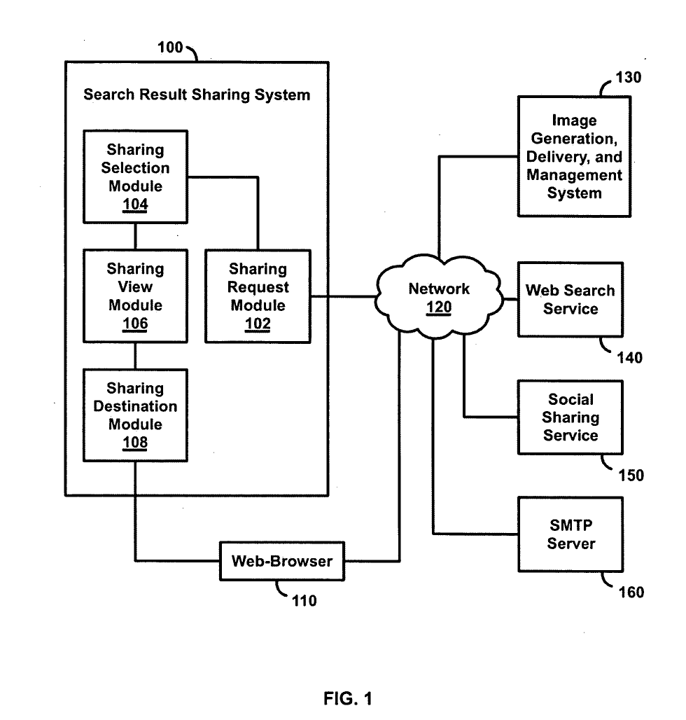

Referring to FIG. 1, there is shown a diagram of a search result sharing system (100) for sharing search results and associated content received over a network, in accordance with principles of the present invention. The system (100) is part of an application adapted to provide search results associated with a search term. The application can be resident on a computer, a website, blog, forum, aggregator, and other suitable web-enabled application.

The system (100) is preferably implemented in hardware, software, or a suitable combination of hardware and software thereof and may comprise one or more software systems operating on a digital signal processing platform or other suitable processing platforms.

As used herein, “hardware” can include a combination of discrete components, an integrated circuit, a microprocessor, a controller, a microcontroller, an application-specific integrated circuit (ASIC), an electronic data processor, a computer, a field programmable gate array, or other suitable hardware connectable for interfacing with a network, such as the Internet, considered to be well-known in the art.

As used herein, “software” can include one or more objects, agents, threads, lines of code, subroutines, separate software applications, two or more lines of code or other suitable software structures operating in two or more software applications or on two or more processors, or other suitable hardware structures. Furthermore, it is considered that the design, development, and implementation details of all such hardware and software would be apparent to a person having ordinary skill in the art based upon a review of the present description of the invention.

In one embodiment, software can include one or more lines of code or other suitable software structures operating in a general purpose software application, such as an operating system, and one or more lines of code or other suitable software structures operating in a specific purpose software application.

The system (100) is operably coupled to web-browser (110), image generation, delivery, and management system (130), web search service (140), web search service (150), and SMTP server (160) by network (120). The network can be a WAN, MAN, LAN, PAN, or other suitable network configuration. The system (100) is adapted to receive a request to share one or more search results from a web-browser (110) and generate a message, containing the search results and associated content, to be shared via network (120).

The system (100) determines which results a user desires to share, formats the search result and associated content according to a user-selected view, and generates an HTML message. The system (100) in this embodiment also includes sharing request module (102), sharing selection module (104), sharing view module (106), and sharing destination module (108).

The sharing request module (102) is adapted to instantiate sharing selection module (104). In one embodiment, the user can select an icon in the web-browser (110) to signal the application that the user desires to share one or more search results. In a second embodiment, a first icon is disposed proximate each search result, indicating that the search result associated with the first icon can be shared. In a third embodiment, a second icon is disposed in a search result display area of the web-browser (110), indicating that one or more search results retrieved by the application can be shared. The sharing request module (102) can be achieved with an application programming interface (API), a network connection, a network transfer protocol, HTML, DHTML, JavaScript, Dojo, Ruby, Rails, other suitable formats and applications, or a suitable combination thereof.

The sharing selection module (104) is adapted to allow the user to select which search results to share. In one embodiment, the sharing selection module (104) stores the search result in a first database based on selection of the first icon. The first database can be memory available to the application located on the user's device, such as cache memory. In a second embodiment, the sharing selection module (104) prompts the user to select which results are to be shared by generating a checkbox proximate each search result. The sharing selection module (104) stores each checked search result in the first database. In a third embodiment, the sharing selection module (104) allows the user to share all search results rendered in the web-browser (110). The sharing selection module (104) stores each search result rendered in the web-browser (110) in the first database. In a fourth embodiment, the sharing selection module (104) allows the user to share search results saved by the user. The sharing selection module (104) stores each search result saved by the user in the first database. The content templating system (104) can be achieved with an application programming interface (API), a network connection, a network transfer protocol, HTML, DHTML, JavaScript, Dojo, Ruby, Rails, other suitable formats and applications, or a suitable combination thereof.

The sharing view module (106) is adapted to allow the user to select a sharing view with which to share the selected search result(s) and generates a sharing message having the selected search result(s) and associated content, according to the sharing view. In one embodiment, the sharing view module (106) prompts the user to select one of at least three sharing views: a summary view, a line view, and a gallery view. In a second embodiment, the sharing view module (106) also allows the user to select a mobile sharing view, optimized for mobile devices. The sharing view module (106) retrieves the selected search result(s) from the first database and generates the sharing message according to a template associated with the selected sharing view.

A template-customized HTML image tag (IMG) is generated to provide an image associated with each search result, where applicable, and inserts it into the appropriate location in the sharing message. The IMG contains the height and width attributes of the image size appropriate for the view. The source attribute (SRC) of the IMG tag is populated with a base image request URL, pointing to the image generation, delivery, and management system (130).

The image request system (106) generates a full image request URL by appending a requested width, taken from the width attribute, and a requested height, taken from the height attribute, and the search result URL to the base image request URL. The image request system (106) can be achieved with an application programming interface (API), a network connection, a network transfer protocol, HTML, DHTML, JavaScript, Dojo, Ruby, Rails, other suitable formats and applications, or a suitable combination thereof.

The sharing destination module (108) prompts the user to determine how and where the sharing message is to be shared and generates the code required to share the sharing message. The sharing destination module (108) determines if the user wants to e-mail or post the sharing message. In one embodiment, the user desires to e-mail the sharing message. The sharing destination module (108) prompts the user for the user's name and e-mail address and the recipient's name and e-mail address, and generates an e-mail, having the sharing message, addressed to the recipient from the user. The e-mail is transmitted via network (120) to the SMTP server (160) for delivery. The SMTP server (160) can be the SMTP server associated with the sender's e-mail address or other SMTP server.

In a second embodiment, the user desires to post the sharing message to a network location, such as the social sharing service (150). The sharing destination module (108) prompts the user to select which social sharing service (150) and generates an HTML post for posting the sharing message to the social sharing service (150) account. In a second embodiment, the user selects the social sharing service (150) by typing in the social sharing service (150) URL.

In a third embodiment, the user selects the social sharing service (150) by selecting a radio button associated with one of a plurality of social sharing services displayed in a pop-up window. The sharing destination module (108) uses the API associated with the social sharing service (160), or other suitable protocol, such as FTP, to transmit the post via network (120) to the social sharing service (150) account. The social sharing service (150) account information can be supplied to the sharing destination module (108) by the user via a pop-up window, or input at the social sharing service (150) site once the post is transmitted to the social sharing service (150). The sharing destination module (108) can be achieved with an application programming interface (API), a network connection, a network transfer protocol, HTML, DHTML, JavaScript, Dojo, Ruby, Rails, other suitable formats and applications, or a suitable combination thereof.

In a fourth embodiment, the user selects to apply the search result to the browser favorites. The browser “favorites” is the list of favorite URL links that is maintained within the web browser for rapid recall by the user. Such list allows the user to maintain links to previously visited websites for subsequent recall.

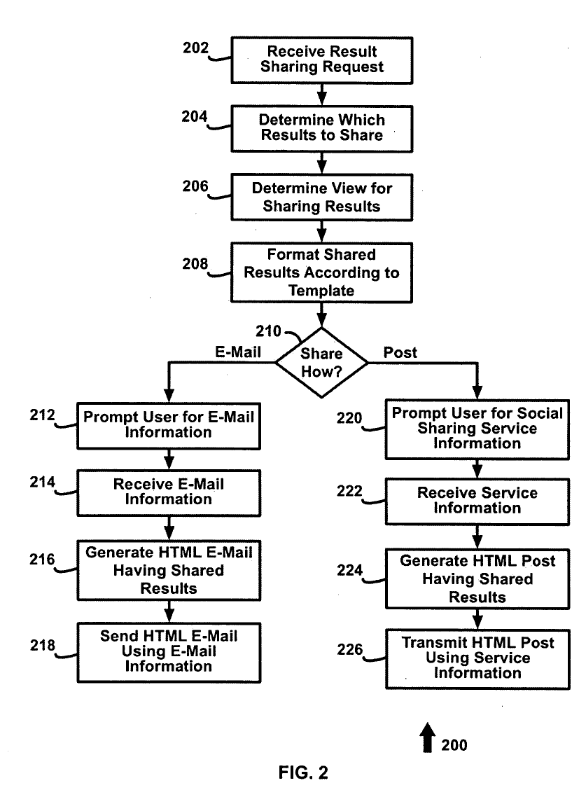

Referring now to FIG. 2, there is shown a flow chart (200) exemplifying control logic embodying features of a method for sharing search results in accordance with principles of the present invention. The search result formatting control logic (200) can be implemented as an algorithm on a general purpose computing platform or other suitable microprocessor-based system.

The search result formatting control logic (200) can leverage the ability of a computer platform to spawn multiple processes and threads by processing data simultaneously. The speed and efficiency of the search result formatting control logic (200) is greatly improved by instantiating more than one process to format images and text associated with a search result for sharing. However, one skilled in the art of programming will appreciate that use of a single processing thread may also be utilized and is within the scope of the present invention.

The search result sharing control logic (200) process flow of the present embodiment begins at step 202, where a sharing request is received from the application. The logic then proceeds to 204.

At step 204, it is determined which search results are to be shared and the selected search results are stored in a first database. In one embodiment, one search result is to be shared. In a second embodiment, all the search results displayed in the web-browser (110) are to be shared. In a third embodiment, a plurality of user-selected search results are to be shared. The logic then proceeds to 206.

At step 206, the sharing view (i.e., the display format) with which the selected search result(s) are to be shared is determined. In the present embodiment the sharing view format may be a summary, gallery, or line view. In one embodiment, the selected search results are to be shared in a summary view. In a second embodiment, the selected search results are to be shared in a gallery view. In a third embodiment, the selected search results are to be shared in a line view. The logic then proceeds to 208.

At step 208, the HTML sharing message, having the selected search results and associated content, is generated from the retrieved selected search result(s) stored in the first database and formatted according to the template associated with the sharing view. The logic then proceeds to 210.

At step 210, the method determines how the sharing message is to be shared. If the sharing message is to be e-mailed, then the logic proceeds to 212. If the sharing message is to be posted, then the logic proceeds to 220.

At step 212, the user is prompted via pop-up window for the e-mail address and name of the user and the recipient. The logic then proceeds to 214.

At step 214, the method receives the e-mail address and name of the user and the recipient. The logic then proceeds to 216.

At step 216, an HTML e-mail is generated having the sharing message, the e-mail addresses, and the associated names. The logic then proceeds to 218.

At step 218, the e-mail is transmitted via network (120) to the SMTP server (160) for delivery. The SMTP server (160) can be the SMTP server associated with the sender's e-mail address or other SMTP server. In one embodiment, the e-mail is transmitted directly from the web-browser (110) to the SMTP server (160) without launching a third-party e-mail application.

At step 220, the user is prompted to select which social sharing service (150) the sharing message is to be posted to. In one embodiment, the user selects the social sharing service (150) to post to by typing in the social sharing service (150) URL. In a second embodiment, the user selects the social sharing service (150) by selecting a radio button associated with one of a plurality of social sharing services displayed in a pop-up window. In a third embodiment, the social sharing service (150) account information is supplied by the user via a pop-up window. The logic then proceeds to 222.

At step 222, the method receives the social sharing service (150) information. The logic then proceeds to 224.

At step 224, an HTML post is generated, having the sharing message and the social sharing service (150) information, for posting to the social sharing service (150) account. The logic then proceeds to 226.

At step 226, the HTML post is transmitted using the API associated with the social sharing service (160), or other suitable means such as FTP put or form post, to transmit the post via network (120) to the social sharing service (150) account. In one embodiment, the social sharing service (150) account information is input at the social sharing service (150) site once the post is transmitted to the social sharing service (150).

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

We claim:

1. A method for sharing one or more search results in a networked environment, the search results for display in an application having a graphical user interface (GUI), the method steps comprising:
providing a plurality of search results in response to a search for information by a user on a computer network, wherein each search result comprises at least one URL and associated content;
providing at least one hyperlink for initiating a result sharing request;
accepting a result sharing request to share at least one result;
accepting a sharing destination for the shared result;
generating a sharing message containing the shared result, wherein the sharing message is based at least in part upon the sharing destination; and
communicating the sharing message to the sharing destination.

2. The method of claim 1, the method steps further comprising:
allowing the user to select specific search results to be shared from the plurality of search results.

3. The method of claim 1, the method steps further comprising:
formatting the shared result content according to a predefined view template before generating the sharing message.

4. The method of claim 3 wherein the view template is chosen from the group consisting of a summary view, a gallery view, and a line view.

5. The method of claim 1 wherein the sharing destination is an email message.

6. The method of claim 1 wherein the sharing destination is a social networking website.

7. A computer software program tangibly embodied in a computer readable medium, the program including machine-readable instructions executable by a computer processor to perform a method for sharing one or more search results, in a networked environment, the search results for display in an application having a graphical user interface (GUI), the program steps comprising:
providing a plurality of search results in response to a search for information by a user on a computer network, wherein each search result comprises at least one URL and associated content;
providing at least one hyperlink for initiating a result sharing request;
accepting a result sharing request to share at least one result;
accepting a sharing destination for the shared result;
generating a sharing message containing the shared result, wherein the sharing message is based at least in part upon the sharing destination; and
communicating the sharing message to the sharing destination.

8. The computer software program of claim 7, the program steps steps further comprising:
allowing the user to select specific search results to be shared from the plurality of search results.

9. The computer software program of claim 7, the program steps steps further comprising:
formatting the shared result content according to a predefined view template before generating the sharing message.

10. The computer software program of claim 9 wherein the view template is chosen from the group consisting of a summary view, a gallery view, and a line view.

11. The computer software program of claim 7 wherein the sharing destination is an email message.

12. The computer software program of claim 7 wherein the sharing destination is a social networking website.

13. An automated system for sharing one or more search results in a networked environment, the search results for display in an application having a graphical user interface (GUI), the system comprising:
a networked computer processor device capable of executing machine-readable instructions to perform the program steps comprising:
providing a plurality of search results in response to a search for information by a user on a computer network, wherein each search result comprises at least one URL and associated content;
providing at least one hyperlink for initiating a result sharing request;
accepting a result sharing request to share at least one result;
accepting a sharing destination for the shared result;
generating a sharing message containing the shared result, wherein the sharing message is based at least in part upon the sharing destination; and
communicating the sharing message to the sharing destination.

14. The system of claim 13, the program steps further comprising:
allowing the user to select specific search results to be shared from the plurality of search results.

15. The system of claim 13, the program steps further comprising:
formatting the shared result content according to a predefined view template before generating the sharing message.

16. The system of claim 15 wherein the view template is chosen from the group consisting of a summary view, a gallery view, and a line view.

17. The system of claim 13 wherein the sharing destination is an email message.

18. The system of claim 13 wherein the sharing destination is a social networking website.
